(19) United States
(12) Patent Application Publication
(10) Pub. No.: US 2010/0098398 A1
(43) Pub. Date: Apr. 22, 2010

(54) METHOD AND DESIGN FOR ADJUSTING FOCUS OF HERMETICALLY SEALED CAMERA

(75) Inventors: Colin DOBELL, Ladysmith (CA); Allen Clifford ROBINSON, Nanaimo (CA)

Correspondence Address: DAVIS & BUJOLD, P.L.L.C., 112 PLEASANT STREET, CONCORD, NH, 03301, US

(73) Assignee: INUKTUN SERVICES LTD., Nanaimo (CA)

(21) Appl. No.: 12/571,469

(22) Filed: Oct. 1, 2009

Related U.S. Application Data
(60) Provisional application No. 61/105,974, filed on Oct. 16, 2008.

(51) Int. Cl. G02B 7/04

(52) U.S. Cl. 396/144

(57) ABSTRACT

A focus adjustment mechanism for a camera, includes a housing defining an interior cavity in which is positioned a helical track. A lens support is provided which supports a lens. The lens support is engaged with the helical track. Rotation of the lens support in a first rotational direction moves the lens support in a first axial direction along the helical track and rotation of the lens support in a second rotational direction moves the lens support in the second axial direction along the helical track. At least one magnet is fixed to the lens support. This construction permits an external magnetic force to be used to selectively cause rotation of the lens support to focus the lens.

### FIELD OF THE INVENTION

The present invention relates to a method and design which allows for the adjustment and setting of the focus of a camera which is contained in a hermetically sealed, epoxy, polyurethane or acrylic resin filled casing, and is unique in that it allows for variable focus optics to be applied to miniature sealed camera units.

### BACKGROUND OF THE INVENTION

The ability to utilize cameras in diverse and often harsh environments has led to the design of numerous containers or cases in which cameras can be sealed. The complexity of the design of such hermetically sealed containers is, for the most part, determined by the expected mechanical, chemical and electromagnetic forces to which the system is likely to be exposed. As such, cases can range from simple plastic molded containers (either manufactured from optically transparent plastics or with an optical window positioned in front of the camera lens) having through case fittings allowing for the control of the camera, to stainless steel or titanium bodies in which the cameras are completely encased in acrylic, polyurethane or epoxy resin. In the latter such systems, harsh environmental forces preclude any through case fittings that would constitute probable sites for seal failures.

A solution developed for underwater photography (typically limited to depths less than 30 meters and larger scale cameras) is the use of magnetically operated push buttons and controls where the magnetic force of repulsion is utilized to transfer mechanical forces across the camera case to the cameras controls (see Boon, U.S. Pat. No. 7,385,645). Such linear repulsive forces are limited to the actuation of push buttons, and require that any buttons be positioned far enough away from each other to avoid co-activation by magnets for adjacent controls. Remote mechanical manipulation (through the application of magnetic forces) of camera parameters, such as focus, is more problematic.

A number of lens focusing mechanisms utilizing magnetic forces have been described (such as Suemori, et al., U.S. Pat. No. 7,233,449: Tsuzuki; Masahiko. U.S. Pat. No. 7,199,945: Manabe; Mitsuo, U.S. Pat. No. 7,221,526). Common limitations of the above approaches are (1) a level of mechanical complexity that precludes these designs from being applied to miniature cameras, and (2) complex mechanical assemblies which cannot be readily encased in epoxy, polyurethane or acrylic resins. As a result, small-scale or miniature encased cameras (such as those used for inspecting the insides of pipes and confined spaces) typically are manufactured with a set focal distance.

### SUMMARY OF THE INVENTION

According to one aspect there is provided a focus adjustment mechanism for a camera, which includes a housing defining an interior cavity in which is positioned a helical track. A lens support is provided which supports a lens. The lens support is engaged with the helical track. Rotation of the lens support in a first rotational direction moves the lens support in a first axial direction along the helical track and rotation of the lens support in a second rotational direction moves the lens support in the second axial direction along the helical track. At least one magnet is fixed to the lens support. An external magnetic force is used to selectively cause rotation of the lens support to focus the lens.

According to another aspect there is provided a method of focal adjustment for a camera. The method involves providing a camera, as described above, positioning an external magnet adjacent to the housing and using an external magnetic force generated by the external magnet to selectively cause rotation of the lens support to focus the lens.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an elevation cross-section drawing of a miniature hermetically sealed video camera.

FIG. 2 is a schematic diagram of an end on view of a miniature hermetically sealed video camera illustrating the radially arranged epoxy-embedded LED illumination system as well as the concentric placement of the ring magnet around the optical axis of the camera.

FIG. 3 is a schematic diagram of a miniature hermetically sealed video camera containing a magnetic force focusing mechanism, illustrating the linear translation of the imaging lens to a forward position.

FIG. 4 is a schematic diagram of a miniature hermetically sealed video camera containing a magnetic force focusing mechanism, illustrating the linear translation of the imaging lens to a rearward position.

FIG. 5 is a schematic diagram illustrating how an externally applied axially rotating magnetic force results in the coupled rotation of the internal ring magnet, leading to a change of focus of the camera.

### DETAILED DESCRIPTION OF THE PREFERRED EMBODIMENT

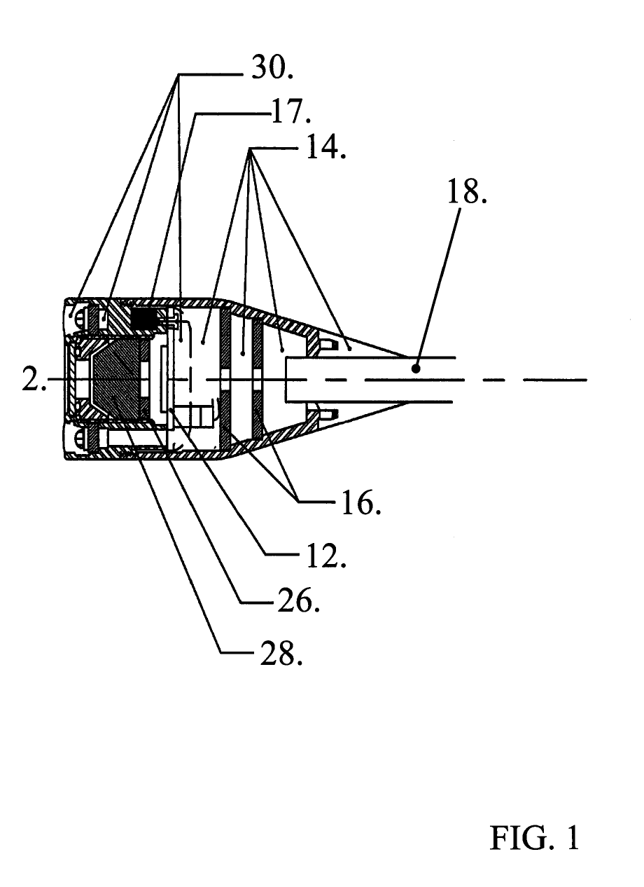

The preferred embodiment, will now be described with reference to schematic diagrams FIGS. 1 through 3.

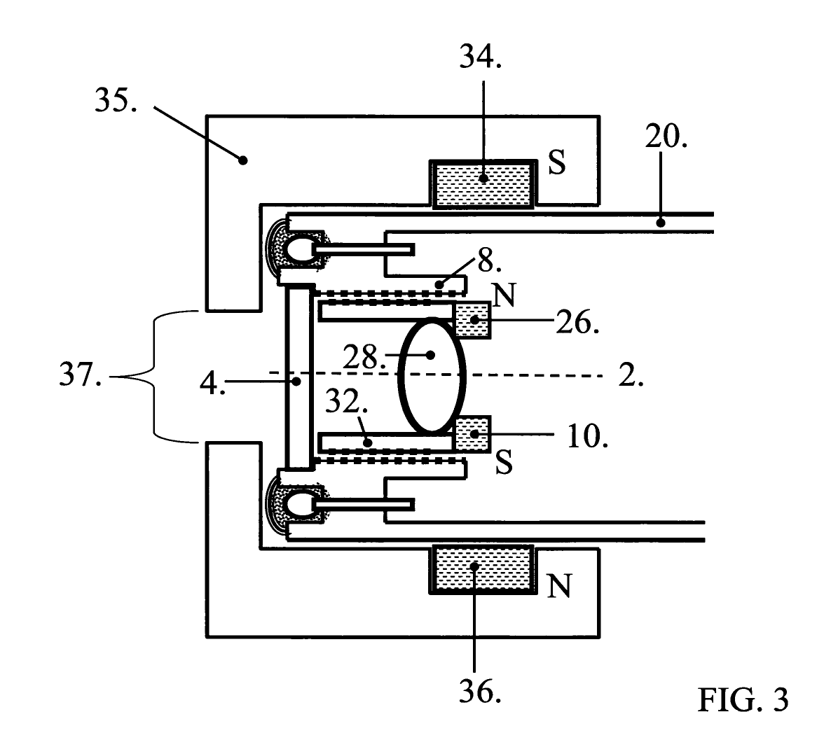

Referring to FIG. 1, there is illustrated an elevation cross-sectional representation of a miniature hermetically sealed camera having a metal casing. Power and control signals are conveyed to the camera, and video output from the camera board 12 is conveyed from the camera through wiring which exits the rear of the camera encased in a single cable/tether 18. Central passages cut through requisite circuit boards 16, allow for the routing of the internal wiring and the filling of the internal voids between the rear of the camera board 12 and the circuit boards 16 with polyurethane resin 14. The front of the camera unit is sealed by (1) the application of a ring of optically clear epoxy resin 30 which encases a number of high-intensity LEDs which form an integrated illumination system, and (2) and optical window (refer to item 4 in FIG. 3) through which the camera images. Light enters the camera through the optical window and is focused along the optical axis 2 by the imaging lens 28 to be brought into focus on the imaging detector.

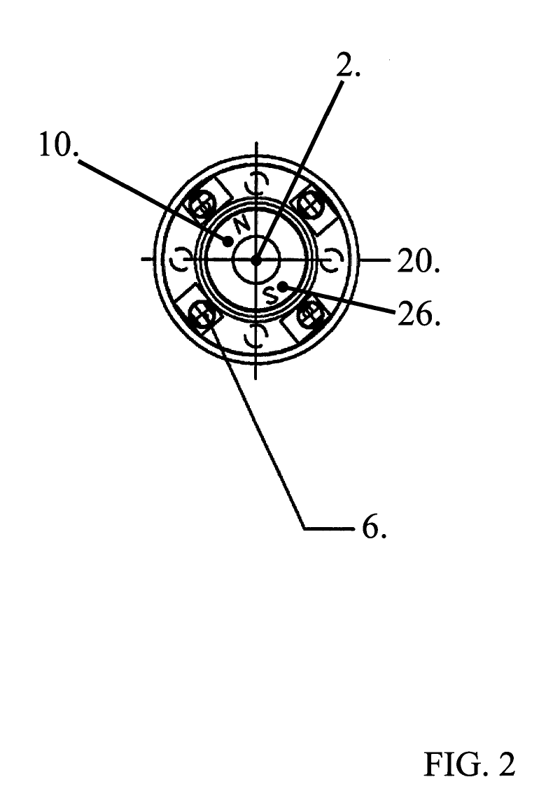

Referring to FIG. 2, there is illustrated a front elevation illustration of a miniature hermetically sealed camera having a metal casing 20. Four LEDs 6 arranged in a concentric ring around the central optical axis 2, and are encased in optically clear epoxy resin. In this view, it can be seen how the ring magnet having its North and South poles (10 and 26 respectively) centered on the optical axis creates an aperture through which imaging can be conducted.

Referring to FIG. 3, there is illustrated a side elevation schematic illustration of a miniature hermetically sealed camera showing that the positions of the North and South poles (10 and 26 respectively) of the ring magnet which is coupled to the lens holder assembly 32 are oriented in a manner as to allow a concentric adapter 35 with embedded magnets (items 34, 36) to create external magnetic forces revolving around the optical axis 2 of the camera to impart matched rotational movement to the ring magnet (10, 26) and the attached lens holder assembly 32. In this example, such rotational movement has been translated into linear translation of the lens holder assembly (collectively items 32, 28, 10, 12) to a forward positioning within the threaded lens assembly holder 8. Consequently, the focal distance between the lens 28 and the imaging board (see item 12 in FIG. 1) has been physically changed inside of a completely sealed camera unit, and the camera can now be focused (through the aperture 37 in the focusing adapter 35) on objects a various distances from the camera.

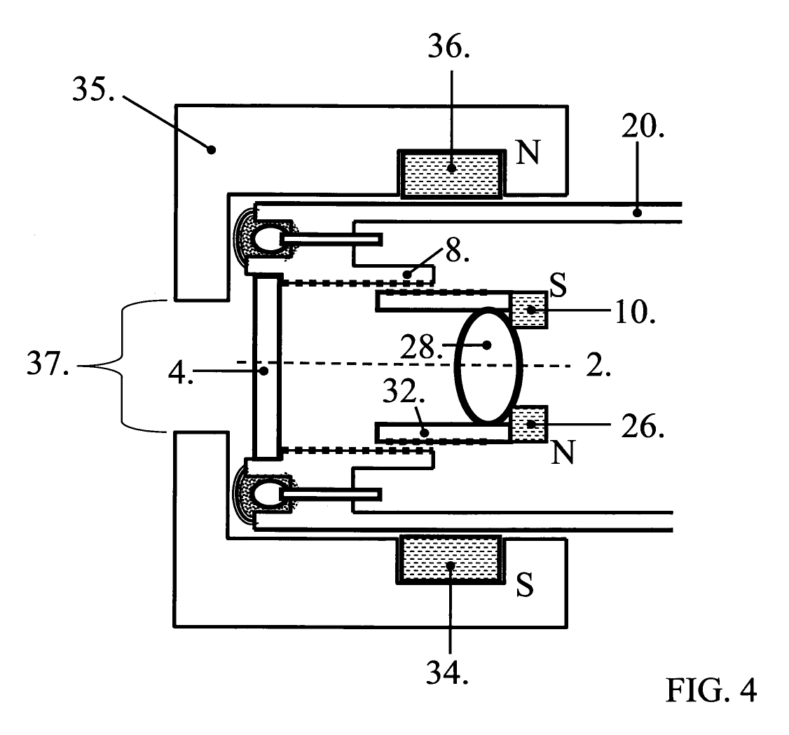

Referring to FIG. 4, there is illustrated a second side elevation schematic illustration of a miniature hermetically sealed camera showing that by axial rotation of the positions of the North and South poles (10 and 26 respectively) of the ring magnet by externally applied magnetic forces (36 and 34 respectively), the attached lens holder assembly 32 has been linearly translated to a rearward position within the threaded lens assembly holder 8. Consequently, the camera will now be focused on objects at a different distance from the camera than before.

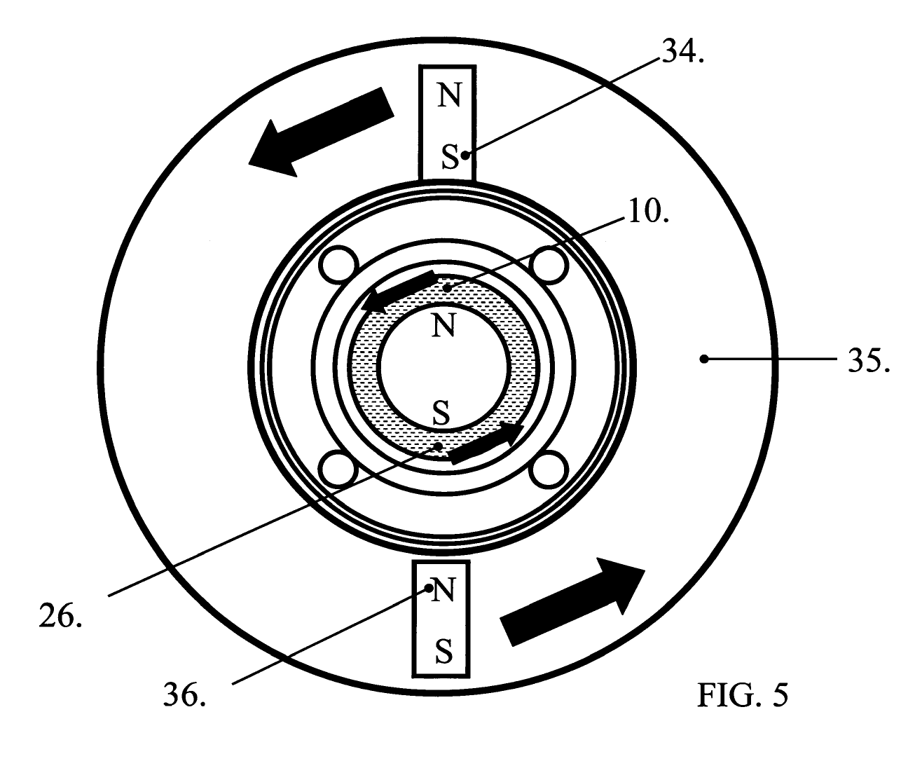

Referring to FIG. 5, there is illustrated a second front elevation schematic illustration of a miniature hermetically sealed camera showing that by axial rotation of the focusing adapter 35 containing embedded magnets. The positions of their North and South poles (36 and 34 respectively) are used to create a rotational force upon the complimentary poles (10 and 26 respectively) of the ring magnet which is attached to the lens holder assembly 32. As such, rotation of the externally applied magnetic force (illustrated by the direction of the large black arrows) produced by rotating the focusing adapter 35, results in a matched rotation (illustrated by the small black arrows) of the lens holder assembly 32. This induced rotational movement is linearly translated to a forward or rearward displacement of the lens holder assembly within the helically threaded lens assembly holder track 8.

A method for adjusting focus of a hermetically sealed miniature camera which is completely encased in epoxy, polyurethane or acrylic resins. A small metal casing is constructed having physical dimensions just sufficient to allow the placement of requisite circuit boards into the lower portion of the case. These circuit boards have a central hole that allows for (1) the routing of electrical connections to the overlying camera and illumination components, and (2) allow for the flow of polyurethane resin into the voids between the rear of the camera board and the other circuit boards. In front of the imaging sensor (in line with the optical axis) is a tube that is an inward extension of the metal casing. This tube possesses fine pitch helical threading which matches that of a barrel insert holding the imaging lens. Affixed to the rear of the imaging lens is a circular magnet, and at the opposite end of a threaded tube is affixed an optical window. The remaining voids at the front of the camera (containing LEDs for illumination) are then filled up with optically clear epoxy resin. The result is a camera completely encased in resin containing only a small void behind the optical window and between the imaging lens and the cameras imaging chip.

It can clearly be seen that since the ring magnet is mechanically affixed to the imaging lens, which itself is firmly held within a tubular structure having helical threading on its outside wall (and that these threads are meshed with matching threads cut into the inward tubular extension of the camera casing), external magnetic fields which are revolved around the optical axis will result in the magnetic transference of rotational force to the lens holder assembly. These rotational forces are then translated (through the helical threading) to a linear displacement of the lens and its holder along the optical axis thereby resulting in a change of the camera's focus.

It will be apparent to one skilled in the art that the invention can be practised with either a permanent magnet or an electro-magnet. When an electro-magnet is used, it is only energized for the purpose of making an adjustment. This allows it to be magnetically inert when passing through sections of pipe which may be subject to magnetic fields that could otherwise trigger an unintended adjustment.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

I claim:

1. A focus adjustment mechanism for a camera, comprising:
a housing defining an interior cavity in which is positioned a helical track;
a lens support supporting a lens, the lens support being engaged with the helical track, with rotation of the lens support in a first rotational direction moving the lens support in a first axial direction along the helical track and rotation of the lens support in a second rotational direction moving the lens support in the second axial direction along the helical track;
at least one magnet fixed to the lens support, such that an external magnetic force is used to selectively cause rotation of the lens support to focus the lens.

2. A method of focal adjustment for a camera, comprising:
providing a camera, comprising:
a housing defining an interior cavity in which is positioned a helical track;
a lens support supporting a lens, the lens support being engaged with the helical track, with rotation of the lens support in a first rotational direction moving the lens support in a first axial direction along the helical track and rotation of the lens support in a second rotational direction moving the lens support in the second axial direction along the helical track;
at least one magnet fixed to the lens support;
positioning an external magnet adjacent to the housing and using an external magnetic force generated by the external magnet to selectively cause rotation of the lens support to focus the lens.
